(19) United States
(12) Patent Application Publication
(10) Pub. No.: US 2008/0014789 A1
(43) Pub. Date: Jan. 17, 2008

(54) Coaxial Cable Grounding Structure, Connector and Method for Connecting Cable In Said Connector

(75) Inventors: Hiroyuki Matsuoka, Tokyo (JP); Takuro Miya, Tokyo (JP)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, St. Paul, MN (US)

(21) Appl. No.: 11/573,336

(22) PCT Filed: Jul. 29, 2005
(86) PCT No.: PCT/US05/26943

§ 371 Date: Feb. 6, 2007

(30) Foreign Application Priority Data
Aug. 6, 2004 (JP) 2004-231261

(51) Int. Cl. H01R 12/08; H01R 12/38

(52) U.S. Cl. 439/579; 439/580

(57) ABSTRACT

[Problem] A coaxial cable grounding structure using no solder exhibits a secure grounding function and a secure cable holding function in keeping with the reduction in the diameter of the cable core wire and the reduced interval between adjacent cables. [Solving Means] A coaxial cable grounding structure (10) comprises a conductive first member (12) and a conductive second member (14). The first member includes first bulges (28) in contact with outer conductors (20) of the exposed length (24) of a first group of coaxial cables (16), and the second member includes second openings (32) for receiving the first bulges and the cable exposed length supported by the first bulges. Further, the second member includes second bulges (34) in contact with the outer conductors of the exposed length of a second group of coaxial cables. The first member includes second bulges and first openings for receiving the cable exposed length supported by the second bulges. The exposed length of each coaxial cable is fixedly held by the friction force while being appropriately bent along the first and second bulges between the first bulges and the second openings one the one hand and between the first openings and the second bulges on the other hand.

### TECHNICAL FIELD

The present invention relates to a coaxial cable grounding structure for grounding the outer conductors of coaxial cables. The present invention also relates to a connector having the coaxial cable grounding structure, and a method for connecting a cable in such a connector.

### BACKGROUND

The coaxial cable, due to the braided or foiled outer conductor (a shield layer) formed over the whole outer periphery of an insulation surrounding each core wire (signal line) and the resultant characteristic resistant to the effects of external noises, finds suitable applications mainly in constructing a high-frequency circuit of various electric and electronic devices such as communication equipment, information equipment, medical equipment and measuring instruments. In connecting a coaxial cable to a device, the outer conductor of the coaxial cable is required to be securely connected to the grounding section of the device.

The conventional coaxial cable grounding structure of this type widely employs a configuration in which the outer conductors are connected to the grounding section by solder (Patent Reference 1). In the coaxial cable grounding structure described in Patent Reference 1, the outer conductor of each coaxial cable is locally exposed, and the exposed length thereof is held between a first conductive member (or a ground strip) and a second conductive member (or a uniformer). At the same time, the exposed lengths are soldered to the conductive members over the whole periphery of the outer conductors surrounded by the solder supplied between the first and second conductive members.

On the other hand, various coaxial cable grounding structures using no solder have been proposed. Patent Reference 2, for example, discloses a coaxial cable grounding structure in which a metal case mounted on the insulating body of a connector is kept in pressure contact with the outer conductor of each coaxial cable through a spring plate section formed on the metal case. Also, Patent Reference 3 discloses a coaxial cable grounding structure of what is called the insulation-displacement type, in which a shield plate mounted on the insulating body of a connector is formed with a slit narrower than the outer diameter of the outer conductor of the coaxial cable, and the outer conductor is fitted under pressure into the slit while causing the edge portion of the slit to cut into the sheath of the coaxial cable thereby to secure electrical connection.

All the conventional coaxial cable grounding structures described above have a cable holding function to hold the coaxial cables fixedly in position against the inconvenient tension and bend exerted on the coaxial cables. Due to this cable holding function, the damage to the connecting section between a terminal built in the circuit component parts such as a connector and the core wire of the coaxial cable, which may occur in the case where the external forces such as tension or bend exerted on the coaxial cables, is prevented by holding the cable sheath in the neighborhood of the connecting section.
[Patent Reference 1] Japanese Patent Publication No. 2825492
[Patent Reference 2] Japanese Unexamined Patent Publication (Kokai) No. 2001-85122
[Patent Reference 3] Japanese Unexamined Patent Publication (Kokai) No. 2003-331941

### SUMMARY

In recent years, strong demand has arisen for high-density connection of signal lines for the circuit component parts such as a connector, and to meet this demand, the cable core wire has been reduced in size and the terminals have come to be arranged at narrower pitches. Also in the coaxial cable grounding structure, therefore, the cable core wire is required to be reduced in diameter and the terminals arranged at smaller pitches to reduce the interval between adjacent cables in order to meet the demand for high-density connection.

In view of this situation, the conventional coaxial cable grounding structures described above have been found to encounter some problems. The grounding structure of solder type described in Patent Reference 1, for example, poses the problem that in the case where a plurality of coaxial cables are collectively grounded between a pair of conductive members, the molten solder, with the decrease in the interval between adjacent coaxial cables, has a higher tendency to flow out of the conductive members along the sheath of the individual coaxial cables from the grounded area of the coaxial cables. As a result, the mechanical and electrical connection between the outer conductors and the conductive members in the grounded area are liable to become unstable. Also, once the solder that has partially flowed out is solidified, the coaxial cable outside of the connector, for example, may not be easily bent in spite of any desire to do so.

In the grounding structure of spring plate type described in Patent Reference 2, on the other hand, the aforementioned problem is overcome by the elimination of solder. With the increase in the number of cores of the coaxial cables connected to a connector, however, the pressure of the spring plate is increased, and the resultant excessive pressure tends to cause the displacement of the metal case of the connector. This is liable to make the mechanical and electrical connection unstable between the outer conductor of the coaxial cable and the metal case on the one hand and cause each coaxial cable to come off easily from the connector on the other hand. Also, the grounding structure of insulation displacement type described in Patent Reference 3, in spite of the advantage of using no solder, has the tendency of an increased difficulty to form the slit for insulation displacement in the shield plate with the reduction in the size of the core wires of the coaxial cables and the interval of adjacent coaxial cables. In the case where the shield plate is formed with such thin slits at small pitches, the function of the shield plate to hold the cables may be deteriorated.

An object of the present invention is to provide a coaxial cable grounding structure, in which the outer conductor of each coaxial cable can be securely grounded on the one hand and a sufficient cable holding function is exhibited on the other hand in keeping with the reduction in the diameter of the cable core wire, the pitch for terminal arrangement and the interval between adjacent cables to meet the requirement of high-density connection of signal lines without using solder.

Another object of the present invention is to provide a highly reliable connector having the aforementioned coaxial cable grounding structure suitably used for construction of a high-frequency circuit.

A further object of the present invention is to provide a method for connecting a coaxial cable in such a connector.

### BRIEF DESCRIPTION OF DRAWINGS

FIG. 1 is an exploded perspective view showing a coaxial cable grounding structure according to a first embodiment of the present invention.

FIG. 2 is an enlarged view showing the coaxial cable grounding structure of FIG. 1 immediately before being assembled.

FIG. 3 is an enlarged view showing the coaxial cable grounding structure of FIG. 1 after being assembled.

FIG. 4 is a sectional view taken along a line IV-IV in FIG. 3.

FIG. 5 is a sectional view taken along a line V-V in FIG. 4.

FIG. 6 is a sectional view taken along a line VI-VI in FIG. 4.

FIG. 7 is a plan view showing the first and second members in the coaxial cable grounding structure of FIG. 1.

FIG. 8 is a schematic view showing the first and second members of FIG. 7.

FIG. 9 is an exploded perspective view showing a connector according to an embodiment of the invention.

FIG. 10 is a perspective view showing the components of the connector of FIG. 9 together with the coaxial cables.

FIG. 11 is an enlarged view showing the coaxial cable grounding structure assembled in the connector of FIG. 9.

FIG. 12 are sectional views of the components of FIG. 10, in which (a) is a sectional view corresponding to FIG. 5 and (b) a sectional view corresponding to FIG. 6.

FIG. 13 is a perspective view showing the connector of FIG. 9 in an assembled state.

FIG. 14 is a perspective view showing a substrate connector connectable to the connector of FIG. 9.

FIG. 15 is a sectional view showing a connector system including the connector of FIG. 9 and the connector of FIG. 14.

FIG. 16 are sectional views showing a modification of the coaxial cable grounding structure of FIG. 1, in which (a) is a sectional view corresponding to FIG. 5 and (b) a sectional view corresponding to FIG. 6.

FIG. 17 is a partially enlarged perspective view showing a coaxial cable grounding structure according to a second embodiment of the present invention.

FIG. 18 is a view showing a modification of the coaxial cable grounding structure of FIG. 1 or FIG. 17.

FIG. 19 is an enlarged view showing a component of the modification of FIG. 18.

FIG. 20 is an enlarged view for explaining the operation of the modification of FIG. 18.

FIG. 21 is a sectional view for explaining the operation of the modification of FIG. 18.

### DETAILED DESCRIPTION

In order to accomplish the above objects, the invention described in claim 1 provides a coaxial cable grounding structure, comprising a conductive first member and a conductive second member fixedly arranged on the first member, wherein a plurality of coaxial cables are held between the first member and the second member, and the first member and the second member are electrically connected individually to outer conductors of the coaxial cables, characterized in that each of the coaxial cables has an exposed length with the outer conductor locally exposed; the first member includes a first bulge for supporting exposed lengths of a first group of the coaxial cables and brought into contact with the outer conductors of the exposed lengths; the second member includes a second opening for receiving the first bulge of the first member and the exposed lengths of the first group of the coaxial cables supported on the first bulge; and the first member and the second member are securely coupled to each other, and the exposed lengths of the first group of the coaxial cables being fixedly held by a friction force, while being bent along the first bulge, between the first bulge of the first member and the second opening of the second member.

The invention described in claim 2 provides a coaxial cable grounding structure, as set forth in claim 1, wherein the first member includes a plurality of first bulges for individually supporting the exposed lengths of the first group of the coaxial cables; and wherein the second member includes a plurality of second openings for individually receiving the first bulges and the exposed lengths of the first group of the coaxial cables individually supported on the first bulges.

The invention described in claim 3 provides a coaxial cable grounding structure, as set forth in claim 1 or 2, wherein the second opening of the second member includes an edge portion coming into local contact with the outer conductors of the exposed lengths of the first group of the coaxial cables received in the second opening.

The invention described in claim 4 provides a coaxial cable grounding structure, as set forth in claim 3, wherein the first bulge of the first member includes a crest area projecting through the second opening of the second member, and supports the exposed lengths of the first group of coaxial cables with the exposed lengths being bent along the crest area, so as to locally press the outer conductors of the exposed lengths onto the edge portion of the second opening.

The invention described in claim 5 provides a coaxial cable grounding structure, as set forth in any one of claims 1 to 4, wherein the second opening of the second member includes an edge portion coming into local frictional engagement with the first bulge of the first member received in the second opening.

The invention described in claim 6 provides a coaxial cable grounding structure, as set forth in any one of claims 1 to 5, wherein the second member further includes a second bulge, arranged adjacent to the second opening, for supporting the exposed lengths of a second group of the coaxial cables and brought into contact with the outer conductors of the exposed lengths; and wherein the first member further includes a first opening, arranged adjacent to the first bulge, for receiving the second bulge of the second member and the exposed lengths of the second group of the coaxial cables supported on the second bulge; and wherein the exposed lengths of the second group of the coaxial cables are respectively bent along the second bulges and fixedly held by a friction force between the first opening of the first member and the second bulge of the second member.

The invention described in claim 7 provides a coaxial cable grounding structure, as set forth in claim 6, wherein the second member includes a plurality of second bulges for individually supporting the exposed lengths of the second group of the coaxial cables; and wherein the first member includes a plurality of first openings for individually receiving the second bulges and the exposed lengths of the second group of the coaxial cables individually supported on the second bulges.

The invention described in claim 8 provides a coaxial cable grounding structure, as set forth in claim 6 or 7, wherein the first opening of the first member includes an edge portion coming into local contact with the outer conductors of the exposed lengths of the second group of coaxial cables received in the first opening.

The invention described in claim 9 provides a coaxial cable grounding structure, as set forth in claim 8, wherein the second bulge of the second member includes a crest area projecting through the first opening of the first member, and supports the exposed lengths of the second group of coaxial cables with the exposed lengths being bent along the crest area, so as to locally press the outer conductors of the exposed lengths onto the edge portion of the first opening.

The invention described in claim 10 provides a coaxial cable grounding structure, as set forth in any one of claims 6 to 9, wherein the first opening of the first member includes an edge portion coming into local frictional engagement with the second bulge of the second member received in the first opening.

The invention described in claim 11 provides a coaxial cable grounding structure, as set forth in any one of claims 6 to 10, wherein the first bulge and the first opening of the first member are arranged alternately with each other; and wherein the second bulge and the second opening of the second member are arranged alternately with each other in correspondence to an alternate arrangement of the first bulge and the first opening.

The invention described in claim 12 provides a coaxial cable grounding structure, as set forth in claim 11, wherein a shape and a dimension of the first bulge of the first member are defined by shapes, dimensions and pitch of a pair of first openings arranged at both sides of the first bulge, and wherein a shape and a dimension of the second bulge of the second member is defined by shapes, dimensions and pitch of a pair of second openings arranged at both sides of the second bulge, and wherein, when the first bulge is press-fitted into the second opening and the second bulge is press-fitted into the first opening, the first member and the second member are securely held with each other.

The invention described in claim 13 provides a coaxial cable grounding structure, comprising a conductive first member and a conductive second member fixedly arranged on the first member, wherein a plurality of coaxial cables are held between the first member and the second member, and the first member and the second member are electrically connected, individually, to outer conductors of the coaxial cables, characterized in that the first member includes a plurality of first bulges for individually supporting the coaxial cables; the second member includes a plurality of second openings for individually receiving the first bulges of the first member and the coaxial cables individually supported on the first bulges; and when the first member and the second member are securely coupled to each other, edge portions of the second openings respectively cut into sheaths of the coaxial cables individually received in the second openings together with the first bulges, to securely hold the coaxial cables in a form bent along the first bulges, and to come into contact with the outer conductors of the coaxial cables under pressure.

The invention described in claim 14 provides a coaxial cable grounding structure, as set forth in any one of claims 1 to 13, further comprising a packing material held between the first member and the second member and contacting with the outer conductors of the coaxial cables.

The invention described in claim 15 provides a coaxial cable grounding structure, as set forth in any one of claims 1 to 14, further comprising a plurality of holding elements provided on at least one of the first member and the second member for securely holding, individually and under pressure, the sheaths of the coaxial cables fixedly held between the first bulges and the second openings, at a position remote from the first bulges and the second openings.

The invention described in claim 16 provides a coaxial cable grounding structure, as set forth in claim 15, wherein the plurality of holding elements individually cut into the sheaths of the coaxial cables fixedly held between the first bulges and the second openings, and come into contact with the outer conductors of the coaxial cables under pressure.

The invention described in claim 17 provides a connector comprising a coaxial cable grounding structure as set forth in any one of claims 1 to 16.

The invention described in claim 18 provides a connector, as set forth in claim 17, further comprising a plurality of terminals, a body supporting the terminals and the coaxial cables in corresponding arrangements, and a shield member assembled to the body, wherein the shield member is provided with the first member of the coaxial cable grounding structure and a connecting portion for electrically connecting the first member to a grounding potential of a counterpart connector.

The invention described in claim 19 provides a method for connecting a coaxial cable in a connector as set forth in claim 18, wherein each of the terminals of the connector including an insulation-displacement type conductor-connecting section connectable to a core conductor of each of the coaxial cables, comprising the steps of locating the coaxial cables on the body and the shield member to lay the coaxial cables on the first bulge; receiving the first bulge and the coaxial cables supported on the first bulge in the second opening, so as to secure the second member onto the first member; and attaching the terminals under a pressing force to the body locating the coaxial cables thereon, and connecting each of the coaxial cables to the conductor-connecting section of each of the terminals in an insulation displacing manner.

According to the invention described in claim 1, the outer conductors of the first group of the coaxial cables can be collectively connected to the first and second members fixedly without solder. Therefore, even in the case where the interval at which adjacent coaxial cables are arranged is reduced, the inconvenience of the molten solder flowing out of the first and second members along the sheath of the individual coaxial cables which otherwise might occur is eliminated. Also, adverse effects on the environment that would otherwise be brought about by the use of solder can be suppressed. Further, the outer conductors and the first and second members are connected to each other in such a manner that the first bulge of the first member are received by the second opening of the second member, so that the exposed length of the first group of the coaxial cables are held by the friction force between the first and second members while being bent in the direction substantially at right angles to the direction parallel to the cables. Unlike in the conventional grounding structure of spring plate type, therefore, even an increased number of coaxial cables cause no deformation of the first and second members under the spring force. Further, with this connection, unlike in the conventional grounding structure of insulation displacement type, even in the case where the size of the core wire of the coaxial cable or the interval between adjacent coaxial cables is reduced, the first bulge and the second opening of a corresponding size can be formed in the first and second members without reducing the strength of the first and second members. In the coaxial cable grounding structure according to the invention, therefore, the outer conductors of the coaxial cables can be grounded securely while exhibiting a sufficient cable holding function in keeping with the reduction in the diameter of the cable core wire or the reduction in the pitch at which the terminals are arranged, thereby meeting the requirement of high-density connection of signal lines.

According to the invention described in claim 2, the exposed lengths of the first group of the coaxial cables are firmly held, one by one, between the first and second members. Also, each exposed length and the corresponding first bulge are kept in more stable contact with each other. Thus, the outer conductor of each coaxial cable can be grounded more securely while at the same time exhibiting a strong cable holding function.

According to the invention described in claim 3, the outer conductor of each coaxial cable is mechanically and electrically connected to the first and second members at a plurality of points. As a result, each coaxial cable can be grounded more stably.

According to the invention described in claim 4, the crest area of the first bulge acts in a wedge-like manner to further improve the stability and mechanical holding strength of the grounding of the coaxial cable.

According to the invention described in claim 5, the first member and the second member can be coupled fixedly to each other both quickly and positively without using means such as soldering or welding.

According to the invention described in claim 6, the outer conductors of the second group of the coaxial cables different from the first group of the coaxial cables are connected collectively and fixedly to the first and second members without any solder. Also, the outer conductors and the first and second members are connected to each other in such a manner that the second bulge of the second member is received in the first opening of the first member, and therefore, the exposed lengths of the second group of the coaxial cables are held by the friction force between the first and second members while being bent in the direction at right angles to the direction parallel to the cables. Thus, the problem associated with the conventional grounding structures of spring plate type and insulation displacement type can be overcome.

According to the invention described in claim 7, the exposed lengths of the second group of the coaxial cables are firmly held, one by one, between the first and second members. Also, each exposed length and the corresponding first bulge are kept in contact with each other in more stable fashion. As a result, the outer conductors of the coaxial cables can be grounded more stably, while at the same time exhibiting a stronger cable holding function.

According to the invention described in claim 8, the outer conductor of each coaxial cable is connected mechanically and electrically at a plurality of points to the first and second members. As a result, each coaxial cable can be grounded with a higher stability.

According to the invention described in claim 9, the crest area of the second bulge acts in a wedge-like manner to further improve the stability and mechanical holding strength of the grounding of the coaxial cable.

According to the invention described in claim 9, the first and second members can be fixedly coupled to each other both quickly and positively without using means such as soldering or welding.

According to the invention described in claim 11, the exposed lengths of the first group of the coaxial cables and the exposed lengths of the second group of the coaxial cables are arranged alternately with each other while being bent differently, and are held between the first and second members. Thus, the cable holding function is further enhanced by the cooperation of the respective friction forces.

According to the invention described in claim 12, it is possible to readily realize a configuration wherein the respective first bulges are fitted into the corresponding second openings and the respective second bulges are fitted into the corresponding first openings under pressure so as to securely hold the first and second members together, merely by suitably forming the first and second openings in a press forming process.

According to the invention described in claim 13, it is possible to obtain effects similar to those of the invention described in claim 1 by using a conductor-connecting structure of an insulation displacement type in the second openings, so that it is possible to simplify the terminating process of the coaxial cable.

According to the invention described in claim 14, the packing material has beneficial effects such as assisting an electrical connection between the first and second members and the outer conductors of the coaxial cables, or preventing the oxidation of the outer conductors of the coaxial cables.

According to the invention described in claim 15, it is possible to significantly improve the cable holding function (or a tension relaxing effect) for the respective coaxial cables.

According to the invention described in claim 16, it is possible to realize, for the grounding of the coaxial cables, a multi-point connection structure having improved electrical and mechanical stability.

According to the invention described in claim 17, there is provided a highly reliable connector suitably applicable to the construction of a high-frequency circuit, comprising a coaxial cable grounding structure exhibiting the operational effects described above.

According to the invention described in claim 18, it is possible to stably connect the coaxial cable grounding structure of the connector to the grounding potential of the counterpart connector.

According to the invention described in claim 19, it is possible to easily connect the coaxial cable to the connector capable of realizing the stable coaxial cable grounding structure.

Embodiments of this invention are explained in detail below with reference to the accompanying drawings. In all the drawings, similar or identical component elements are designated by the same reference numerals, respectively.

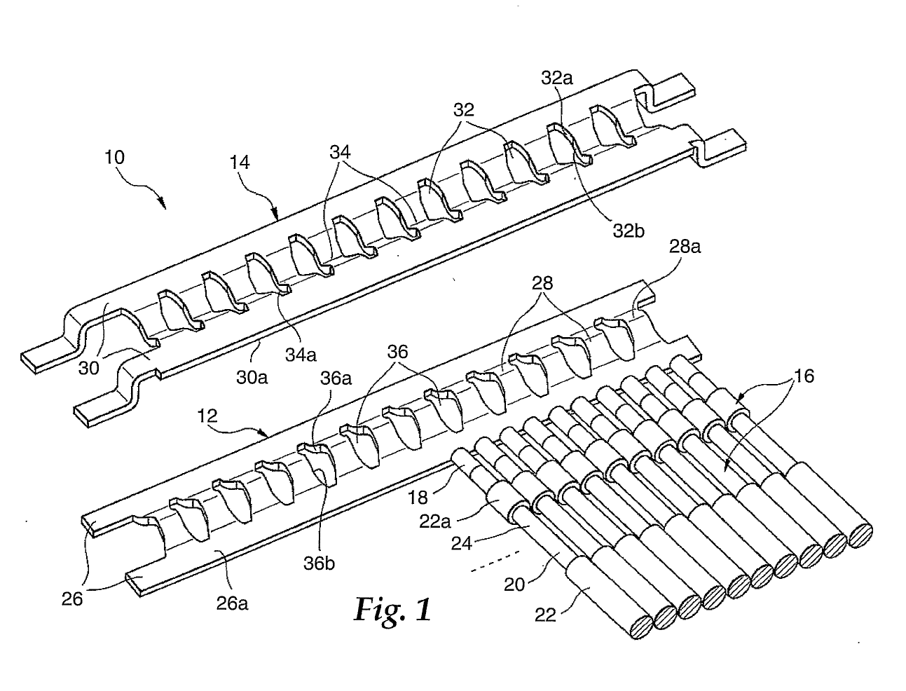

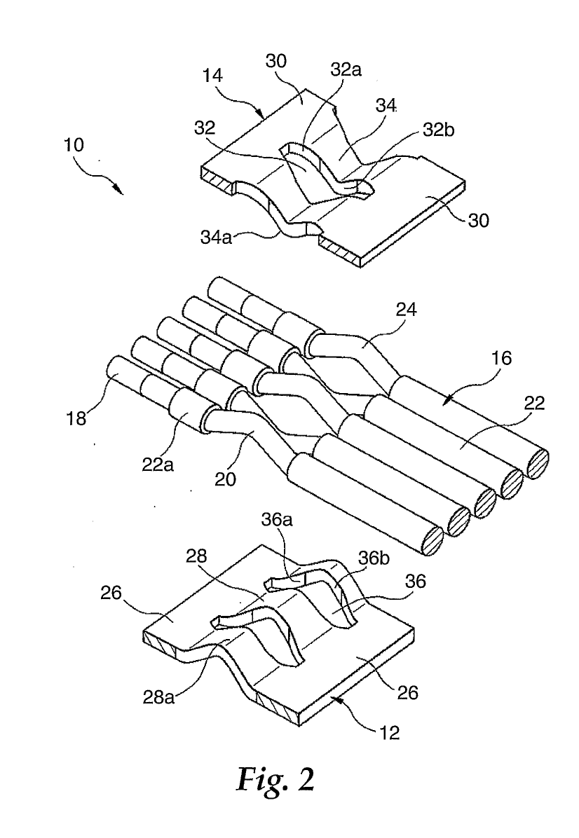

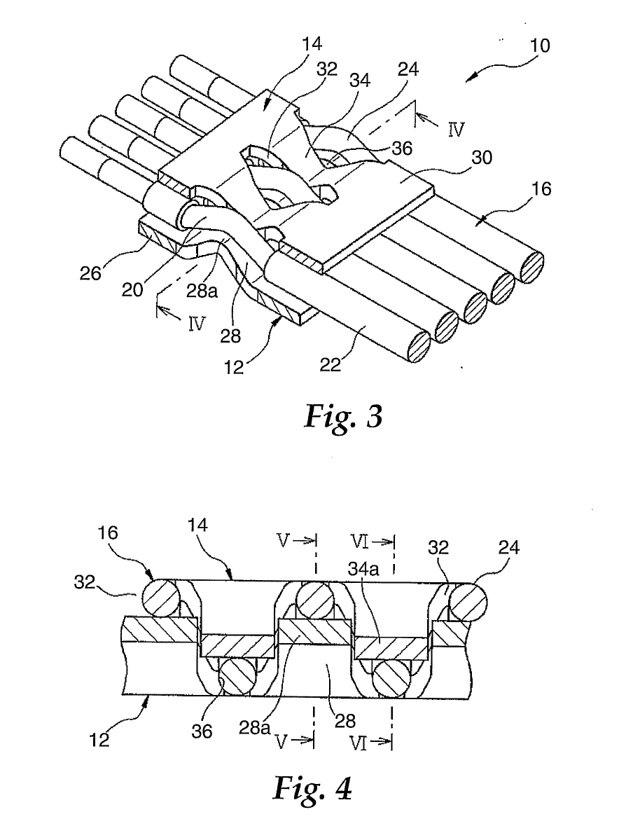

Referring to the drawings, FIG. 1 is an exploded perspective view showing a coaxial cable grounding structure 10 according to an embodiment of the invention, FIG. 2 is a partly enlarged view of the coaxial cable grounding structure immediately before being assembled, FIG. 3 is a partly enlarged view showing the coaxial cable grounding structure immediately after being assembled, and FIGS. 4 to 6 are sectional views of the coaxial cable grounding structure 10 after being assembled.

As shown in FIG. 1, the coaxial cable grounding structure 10 includes a conductive first member 12 and a conductive second member 14 capable of being fixedly arranged on the first member 12. The first and second members 12, 14 are both thin plate members of a good electric conductor such as a metal having rigidity, and formed by punching and bending a plate metal material into a predetermined shape. A plurality of coaxial cables 16 are held between the first and second members 12, 14. Each coaxial cable 16 includes an insulation 18 surrounding a core wire (not shown), a braided or foiled outer conductor over the whole outer periphery of the insulation 18 and a sheath 22 of resin covering the whole outer conductor 20.

The coaxial cable grounding structure 10, in the assembled state (FIG. 3) to be described later, is composed of the first member 12 and the second member 14 electrically connected to the outer conductor 20 of each coaxial cable 16 without using any solder. The coaxial cable grounding structure 10 properly assembled is electrically connected, directly or in the form built in a circuit component part such as a connector, to the grounding section of any of various electric and electronic devices such as communication equipment, informational equipment, medical equipment and measuring instruments.

Each coaxial cable 16 to be grounded has the locally exposed length 24 of the outer conductor 20 formed by removing the sheath 22 over a predetermined length in the vicinity of a terminating end. The terminating end of the coaxial cable 16 is processed in such a manner that, as shown in the drawings, the sheath 22 is removed over the predetermined length of the terminating end. At the same time, the outer conductor 20 is rolled up to expose the insulation 18. Further, in the vicinity of the insulation 18, an exposed length 24 is formed via a short residual sheath 22a to hold the outer conductor 20.

The first member 12 includes a pair of flat plate-like bases 26 extending in parallel to each other and a plurality of first bulges 28 arranged between and integrated with the bases 26 in the shape of hills projecting from one surface 26a of the bases 26. The first bulges 28 support the exposed length 24 of the first group (or a group of alternate coaxial cables, in the illustrated embodiment) of the coaxial cables 16 and are in conductive contact with the outer conductor 20 of the exposed length 24. Also, the second member 14 includes a pair of flat plate-like bases 30 extending in parallel to each other and a plurality of second openings 32 formed between the bases 30. Each second opening 32 has such a size and a shape as to be capable of receiving the first bulges 28 of the first member 12 and the exposed length 24 of the first group of coaxial cables 16 supported on the first bulges 28.

The second member 14 further includes a plurality of second bulges 34 formed adjacently to the second openings 32, integrated with a pair of bases 30, and projecting between the bases 30 in the shape of hills from one surface 30a of the bases 30. The second bulges 34 support the exposed length 24 of the second group of the coaxial cables 16 (or a group of coaxial cables alternating with the first group, in the illustrated embodiment) and are kept in conductive contact with the outer conductors 20 of the exposed length 24. Also, the first member 12 further includes a plurality of first openings 36 formed between a pair of bases 26 adjacently to the first bulges 28. The first openings 36 each have such a size and shape as to be capable of receiving the second bulges 34 of the second member 14 and the exposed length 24 of the second group of the coaxial cables 16 supported on the second bulges 34.

The first member 12 and the second member 14 are fixedly coupled to each other while holding the coaxial cables 16 in such a manner that the exposed length 24 of the first group of the coaxial cables 16 are set in position with the first bulges 28 and the second openings 32 and the exposed length 24 of the second group of the coaxial cables 16 are set in position with the first openings 36 and the second bulges 34 (FIGS. 2 and 3). In the process, a pair of bases 26 of the first member 12 and a pair of bases 30 of the second member 14 are arranged with the surfaces 26a, 30a in opposed relation to each other. Also, the first bulges 28 of the first member 12 and the second bulges 34 of the second member 14 are fitted into the second openings 32 of the second member 14 and the first openings 36 of the first member 12, respectively, in complementary fashion. In this way, the coaxial cable grounding structure 10 is assembled.

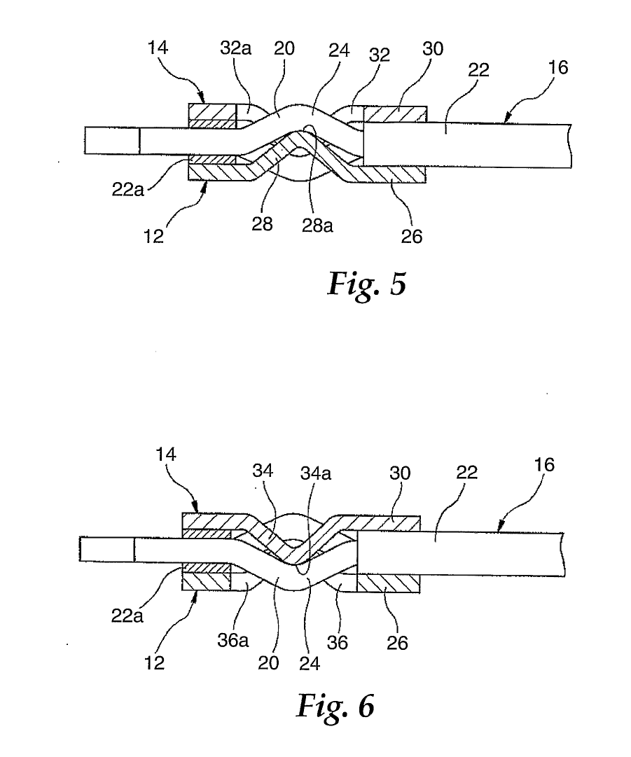

In this assembled state, each exposed length 24 of the first group of the coaxial cables 16 are each fixedly held between the first and second members 12, 14 primarily under the friction force while being appropriately bent along the first bulges 28 between the first bulges 28 of the first member 12 and the second openings 32 of the second member 14 (FIGS. 4 and 5). Also, each exposed length 24 of the second group of the coaxial cables 16 is fixedly held between the first and second members 12, 14 primarily under the friction force while being appropriately bent along the second bulges 34 between the first openings 36 of the first member 12 and the second bulges 34 of the second member 14 (FIGS. 4 and 6). In this connection, the bending direction of the exposed length 24 of each coaxial cable 16 is substantially perpendicular to the orientation of the side-by-side arrangement of the coaxial cables 16.

More specifically, in the above assembled state, the first bulge 28 of the first member 12 includes a crest area 28a projecting through the second opening 32 of the second member 14, so as to support the exposed lengths 24 of the first group of coaxial cables 16 with the exposed lengths being bent along the crest area 28a, and comes into contact with the outer conductor 20 of the corresponding coaxial cable 16 at the crest area 28a. Also, the second bulge 34 of the second member 14 includes a crest area 34a projecting through the first opening 36 of the first member 12, so as to support the exposed lengths 24 of the second group of coaxial cables 16 with the exposed lengths being bent along the crest area 34a, and comes into contact with the outer conductor 20 of the corresponding coaxial cable 16 at the crest area 34a. The friction force generated by the contact of the first bulges 28 and the second bulges 34 with the outer conductors 20 of the coaxial cables 16 constitutes the friction force for holding the exposed length 24 of the coaxial cables 16 between the first and second members 12, 14. Further, the sheaths 22 (including the residual sheath portions 22a) of the coaxial cables 16 are held between the bases 26 of the first member 12 and the bases 30 of the second member 14. In this way, the outer conductors 20 of the coaxial cables 16 are connected to the first member 12 and the second member 14 mechanically and electrically in stable fashion.

With the coaxial cable grounding structure 10 having the configuration described above, the outer conductors 20 of the coaxial cables 16 can be collectively connected to the first and second members 12, 14 fixedly without using solder. Therefore, even in the case where the pitch at which adjacent ones of the coaxial cable 16 are arranged is reduced, the inconvenience of the molten solder flowing out of the first and second members 12, 14 along the sheath 22 of each coaxial cable 16 which otherwise might occur can be prevented. Also, since no solder is used, the effects on the environment can be suppressed.

Also, the outer conductors 20 are connected to the first and second members 12, 14 in such a manner that the first bulges 28 of the first member 12 are received by the second openings 32 of the second member 14 and the second bulges 34 of the second member 14 are received by the first openings 36 of the first member 12. In this way, the exposed length 24 of the coaxial cables 16 are held by the friction force between the first and second members 12, 14 while being bent in the direction generally at right angle to the direction parallel to the cables. Unlike the conventional grounding structure of spring plate type, therefore, one needs not worry about the possibility that an increased number of the coaxial cables 16 might deform the first and second members 12, 14 under the spring force. Further, in this form of connection, unlike in the conventional grounding structure of insulation displacement type, even in the case where the size of the core wire of each coaxial cable 16 or the interval between adjacent coaxial cables 16 is reduced, the first bulges 28, the first openings 36, the second bulges 34 and the second openings 32 of the corresponding size can be formed on the first and second members 12, 14 without adversely affecting the strength thereof. In the coaxial cable grounding structure 10, therefore, the outer conductors 20 of the coaxial cables 16 can be grounded securely while exhibiting a sufficient cable holding function in keeping with the reduction in the diameter of the cable core wires and the pitch at which the terminals are arranged, in such a manner as to meet the requirement of the high-density connection of signal lines.

In the illustrated embodiment, the first member 12 includes a plurality of the first bulges 28 for individually supporting the exposed length 24 of the first group of the coaxial cables 16, and the second member 14 includes a plurality of the second openings 32 for individually receiving the first bulges 28 and the exposed length 24 of the first group of the coaxial cables 16 individually supported by the first bulges 28. Also, the second member 14 includes a plurality of the second bulges 34 for individually supporting the exposed length 24 of the second group of the coaxial cables 16, and the first member 12 includes a plurality of the first openings 36 for individually receiving a plurality of the second bulges 34 and the exposed length 24 of the second group of the coaxial cables 16 individually supported by the second bulges 34. The first bulges 28 and the first openings 36 of the first member 12 are arranged one by one alternately with each other. Similarly, the second bulges 34 and the second openings 32 of the second member 14 are arranged one by one alternately with each other at positions corresponding to the alternate arrangement of the first bulges 28 and the first openings 36.

With this configuration, the exposed length 24 of the coaxial cables 16 are firmly held one by one between the first and second members 12, 14. Also, each exposed length 24 is kept in contact with the corresponding first and second bulges 28, 34 in more stable fashion. As a result, the outer conductors 20 of the coaxial cables 16 can be grounded with higher stability, while at the same time making it possible to exhibit a strong cable holding function. With such an alternate arrangement of differently bent coaxial cables 16, the outer diameter of each core wire can be reduced to 0.09 mm or less (i.e., AWG 40 or more according to American Wire Gauge) and the interval between the center lines to 0.3 mm or less. Also, the first and second members 12, 14 applicable to the high-density cable arrangement can be fabricated by the currently available press forming technique.

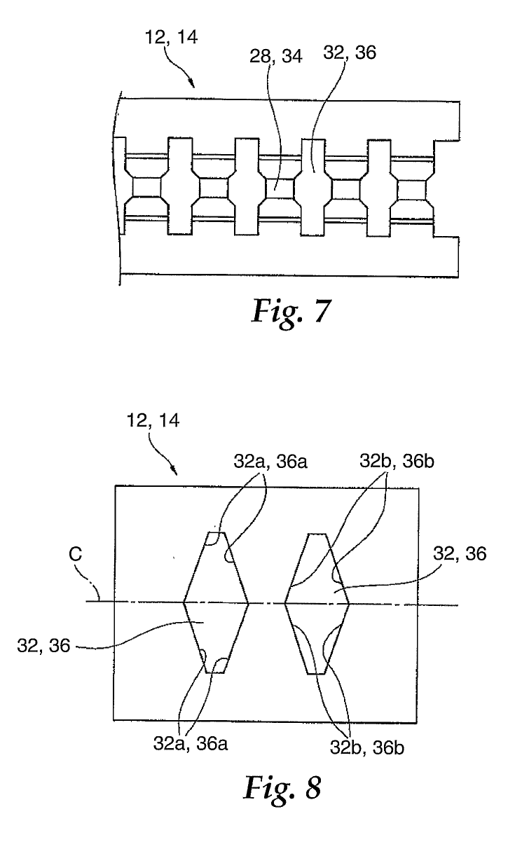

Particularly, in the above configuration, as shown in FIG. 7 as a plan view, the shape and dimension of each first bulge 28 of the first member 12 is defined by the shapes, dimensions and pitch of a pair of first openings 36 arranged at both sides of the first bulge 28. Similarly, the shape and dimension of each second bulge 34 of the second member 14 is defined by the shapes, dimensions and pitch of a pair of second openings 32 arranged at both sides of the second bulge 34. Therefore, it is possible to readily realize a configuration wherein the respective first bulges 28 are fitted into the corresponding second openings 32 and the respective second bulges 34 are fitted into the corresponding first openings 36 under pressure so as to securely hold the first and second members 12, 14 together, merely by suitably forming the first and second openings 36, 32 in a press forming process.

The coaxial cable grounding structure according to this invention is not limited to the configuration according to the embodiments described above, but a configuration can also be employed in which a plurality of the coaxial cables 16 are held by the first member 12 having only one first bulge 28 and the second member 14 having only one second opening 32, for example. As an alternative, the first bulges 28 and the second opening 32 holding one or more coaxial cables 16 on the one hand and the second bulges 34 and the first openings 36 holding one or more coaxial cables 16 on the other hand can be formed in appropriate combinations on the first and second members 12, 14.

In the present invention, as schematically shown in FIG. 8, each of the second openings 32 of the second member 14 advantageously includes an edge portion 32a in local contact with the outer conductor 20 of the exposed length 24 of the first group of the coaxial cables 16 received in the second openings 32. In similar fashion, each of the first openings 36 of the first member 12 advantageously includes an edge portion 36a in local contact with the outer conductor 20 of the exposed length 24 of the second group of the coaxial cables 16 received in the first openings 36. With this configuration, the outer conductor 20 of each coaxial cable 16 is mechanically and electrically connected at a plurality of points to the first and second members 12, 14. As a result, each coaxial cable 16 is grounded in more stable fashion.

In particular, as has been described above, the first bulge 28 of the first member 12 supports the exposed lengths 24 of the first group of coaxial cables 16 with the exposed lengths being bent along the crest area 28a, so that it is possible to locally press the outer conductors 20 of the exposed lengths 24 by the first bulge 28 onto the edge portion 32a of the second opening 32 of the second member 14. Similarly, the second bulge 34 of the second member 14 supports the exposed lengths 24 of the second group of coaxial cables 16 with the exposed lengths being bent along the crest area 34a, so that it is possible to locally press the outer conductors 20 of the exposed lengths 24 by the second bulge 34 onto the edge portion 36a of the first opening 36 of the first member 12. The edge portions 36a, 32a are respectively secured at four points per single first or second opening 36, 32, at symmetrical locations relative to a center line C extending along the parallel arrangement of the first or second openings 36, 32 (FIG. 8). According to this configuration, the outer conductor 20 of each coaxial cable 16 is electrically connected at four points to the second member 14. This multi-point connection serves to further improve a cable holding function (or a tension relaxing effect) for each coaxial cable 16.

Also, in this invention, each of the second openings 32 of the second member 14 advantageously includes an edge portion 32b in local frictional contact with the first bulges 28 of the first member 12 received in the second openings 32. In similar fashion, each of the first openings 36 of the first member 12 advantageously includes an edge portion 36b in local frictional contact with the second bulges 34 of the second member 14 received in the first openings 36. The edge portions 36b, 32b are respectively secured at four points per single first or second opening 36, 32, at symmetrical locations relative to the center line C extending along the parallel arrangement of the first or second openings 36, 32 (FIG. 8). According to this configuration, the first member 12 and the second member 14 can be fixedly connected to each other both quickly and positively without using means such as soldering or welding.

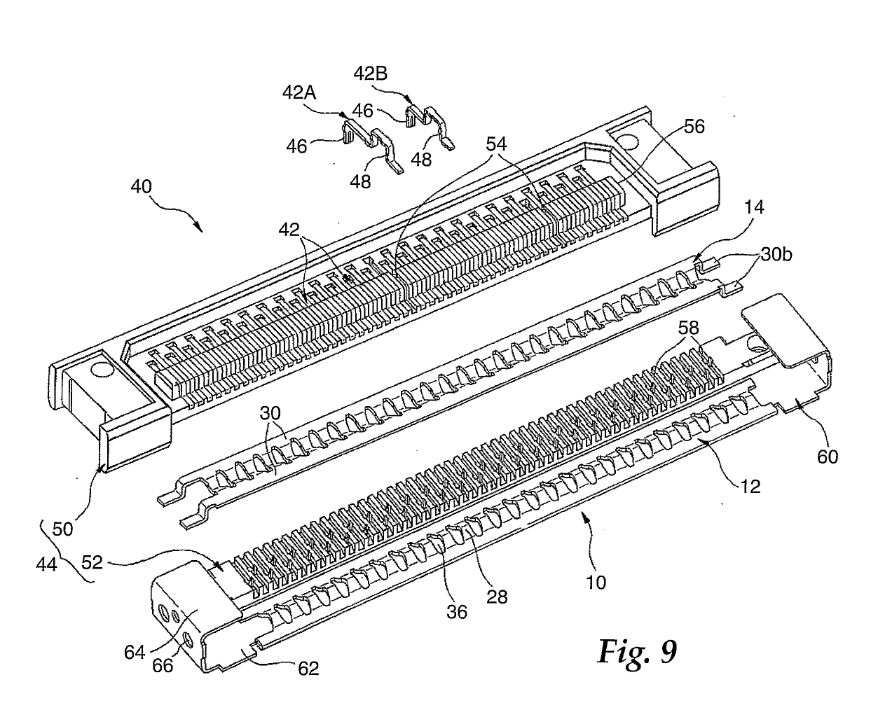

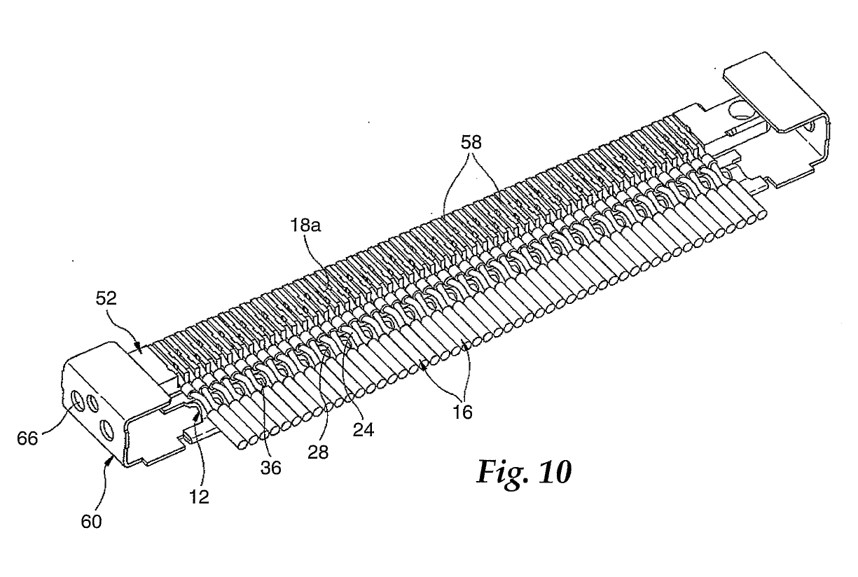

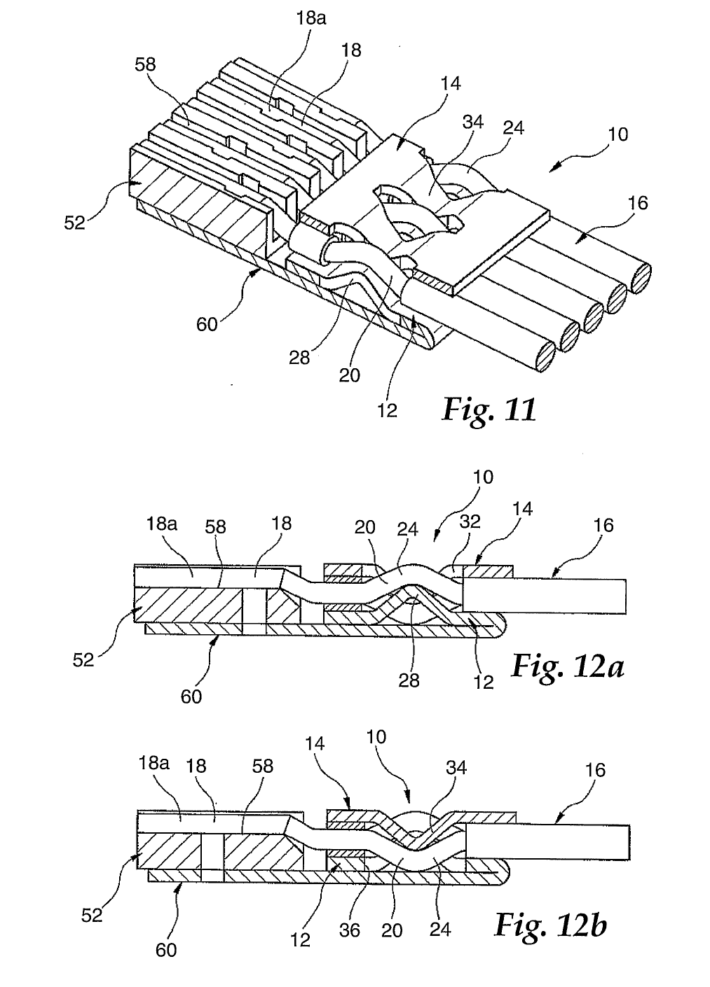

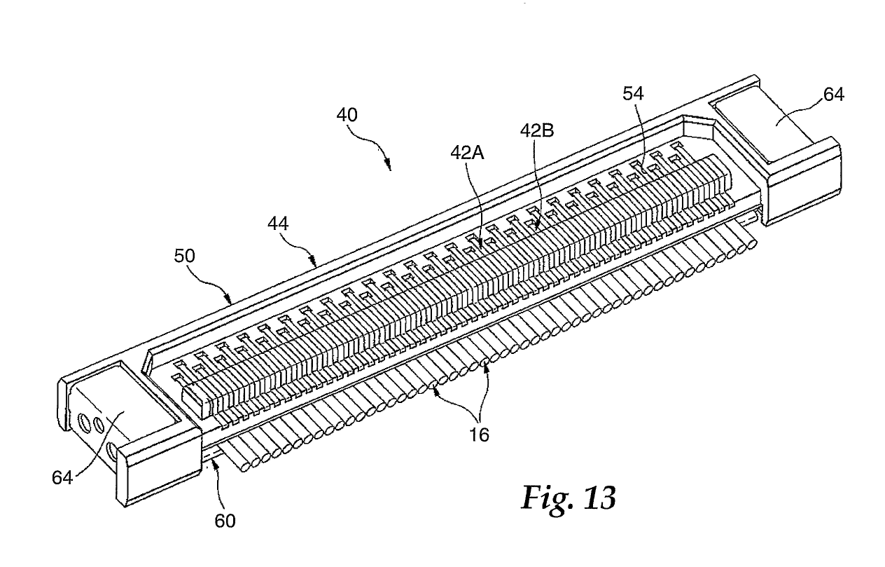

The coaxial cable grounding structure according to this invention can be built in any of the various circuit component parts such as a connector. Now, with reference to FIGS. 9 to 13, the configuration of a connector 40 according to an embodiment of the invention having the coaxial cable grounding structure 10 described above is explained. FIG. 9 is an exploded perspective view of the connector 40 according to an embodiment of the invention, FIG. 10 is a perspective view of the lower component parts of the connector 40, FIGS. 11 and 12 are enlarged views showing the coaxial cable grounding structure 10 of the connector 40, and FIG. 13 is a perspective view of the connector 40 in assembled form.

As shown in FIG. 9, the connector 40 is composed of a plurality of terminals 42, an electrically insulating body 44 for supporting the terminals 42 and a coaxial cable grounding structure 10 arranged on the body 44. The terminals 42 include two types of terminals 42A, 42B having substantially the same shape and partially different lengths. Each of the terminals 42A, 42B has a conductor-connecting section 46 of insulation displacement type connected to the core wire (not shown) of the coaxial cable 16 and a contact section 48 in conductive contact with a corresponding terminal (not shown) of another connector capable of being connected to the connector 40 (referred to as a counterpart connector in the present application).

The body 44 includes, fixedly combined with each other, a first insulating member 50 for supporting a plurality of terminals 42 in spaced-apart parallel arrangement and a second insulating member 52 for supporting a plurality of coaxial cables 16 at corresponding positions in parallel arrangement. The first insulating member 50 includes a plurality of terminal arranging grooves 54 for individually receiving and supporting the terminals 42 at predetermined positions and a fitting portion 56 for setting the contact section 48 of each terminal 42 in position relative to the corresponding terminal of the counterpart connector and fitting with the counterpart connector. The second insulating member 52, on the other hand, includes a plurality of wire retaining grooves 58 for individually receiving the coaxial cables 16.

The second insulating member 52 of the body 44 has a metal shield member 60 built therein. The shield member 60 includes a base portion 62, of generally rectangular shape in plan view, built integrally in the second insulating member 52 and a pair of end plate portions 64 extended in bent form on one surface at the opposite longitudinal ends of the base portion 62. On the base portion 62 of the shield member 60, the first member 12 of the coaxial cable grounding structure 10 is formed along one longitudinal side edge away from the second insulating member 52. In the illustrated embodiment, the first member 12 is integrally formed as an extension of the base portion 62 of the shield member 60, and fixedly arranged relative to the base portion 62 in the form of being folded back 180 degrees therefrom. In this state, the first bulges 28 and the first opening 36 of the first member 12 are aligned in the longitudinal direction of the wire retaining grooves 58 of the second insulating member 52. Further, each end plate portion is provided with three anchoring recesses 66 locally on the outer surface thereof.

As a preparatory work before connecting a plurality of coaxial cables 16 to the connector 40, the end portion of the flattened multi-core coaxial cables 16 are processed as a terminal as described above thereby to form the exposed length and an insulation exposed portion 18a at the extreme end thereof. The insulation exposed portions 18a of the coaxial cables 16 processed as a terminal are inserted in the wire retaining grooves 58 of the second insulating member 52 before being assembled on the first insulating member 50. At the same time, the exposed length 24 of the coaxial cables 16 are individually arranged along the first bulges 28 and the first openings 36 of the first member 12 (FIG. 10).

The second member 14 of the coaxial cable grounding structure 10 is fixedly connected to the first member 12 by following the steps described above, so that the exposed length 24 of the coaxial cables 16 are held between the first member 12 and the second member 14 (FIG. 11). In this state, the insulation exposed portions 18a at the extreme end of the coaxial cables 16 are fixedly held in the wire retaining grooves 58 of the second insulating member 52 of the connector body 44 by the coaxial cable grounding structure 10. At the same time, the outer conductor 20 of each exposed length 24 is electrically connected to a common shield member 60 (FIG. 12(a),(b)).

The second insulating member 52 fixedly supporting the coaxial cables 16 is combined with the insulating member 50 in proper position to form the body 44. In this proper position, the opposite longitudinal end plate portions 64 of the shield member 60 of the second insulating member 52 are bent and folded along the opposite longitudinal end surfaces of the first insulating member 50 into engagement so as to fix the first insulating member 50 and the second insulating member 52 to each other (FIG. 13). In this connection, the end plate portions 64 of the shield member 60 function as a connecting portion for electrically connecting the first member 14 of the coaxial cable grounding structure 10 to a grounding potential of a counterpart connector, as described later. Then, a plurality of terminals 42A, 42B are fitted in the corresponding terminal arranging grooves 54 of the first insulating member 50 on the body 44 with the coaxial cables 16 fixedly held between the first insulating member 50 and the second insulating member 52. Then, the conductor-connecting section 46 of each terminal 42A, 42B cuts into the insulation 18 (FIG. 12) of the insulation exposed portion 18a of the coaxial cable 16 held in the wire retaining groove 58 of the second insulating member 52 and is connected to the core wire in an insulation displacement manner. In this way, the coaxial cables 16 are securely connected by insulation displacement to the corresponding terminals 42A, 42B thereby to complete the assembly of the connector 40.

An external force such as tension or bending force, which may be exerted on the coaxial cables 16 in the completely assembled state, is received by the coaxial cable grounding structure 10 built in the shield member 60, and therefore the connecting section between the conductor-connecting section 46 of each terminal 42 and the corresponding coaxial cable 16 is kept substantially free of the effects of the external force. In the process, the second member 14 of the coaxial cable grounding structure 10 is held between the shield member 60 and the first insulating member 50 and prevented from coming off from the body 44. Against the external force exerted on the coaxial cables 16, therefore, the proper wire connection can be securely maintained. For the grounding function and the cable holding function to be further improved, the second member 14 of the coaxial cable grounding structure 10 is advantageously fixed on the shield member 60 by such means as welding or soldering on the extensions 30b (FIG. 9) formed at the longitudinally opposite ends of a pair of the bases 30.

Since, as described above, the connector 40 includes the coaxial cable grounding structure 10 explained above, it has high reliability, and can be suitably used for construction of a high-frequency circuit. Upon complete assembly of the connector 40, the shield member 60 built in the second insulating member 52 is extended over a major portion of the outer surface of the body 44. Thus, in the case where the shield member 60 electrically connected to the outer conductor 20 of each coaxial cable 16 is connected to the grounding potential of the counterpart connector, for example, the high-speed transmission characteristic of a connector system including the connector 40 and the counterpart connector can be improved by establishing a high-level shield structure for the signal transmission path of the connector system.

In the connector 40 having above configuration, by employing the wire connecting structure of insulation displacement type having high stability and reliability, a high-density connecting structure can be realized in keeping with the reduced diameter of the core wire of the coaxial cable 16 and the reduced pitch at which the terminals 42 are arranged. In order to attain a small-pitch arrangement corresponding to the high-density connection in this connector 40, the conductor-connecting sections 46 of insulation displacement type of the terminals 42 are arranged in staggered fashion using two different types of terminals 42A, 42B having different lengths. As a result, the high-density connecting structure realizable for the connector 40 is so compact that the outer diameter of the core wire of the coaxial cable 16 is 0.09 mm or less (not less than AWG (American Wire Gauge) 40) and the pitch at which the terminals 42 are arranged is not more than 0.3 mm. The conductor-connecting section 46 of each terminal 42 applicable to this high-density connection can be fabricated by the currently available press forming technique. Further, the outer dimensions of the realizable connector 40 may be, for example, 3 to 5 mm in depth and 1 to 2 mm in height.

Incidentally, the counterpart connector to be paired with the connector 40 can be configured as a substrate connector mounted on a circuit board. The connector according to the invention, however, is not limited to such applications but can be embodied as any of various connectors suitable for other applications of connection.

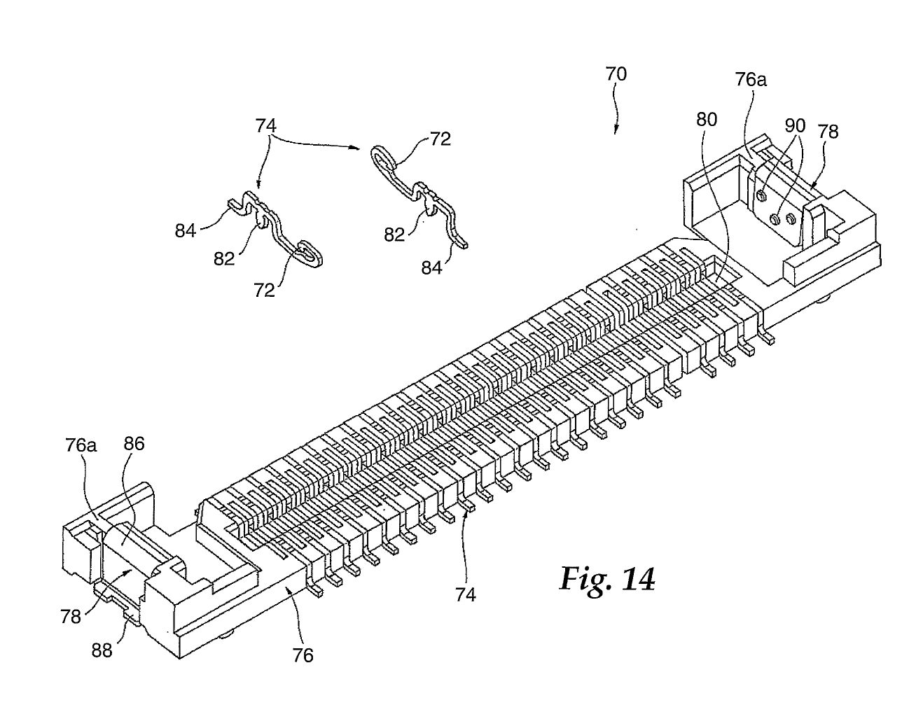

FIG. 14 shows a substrate connector 70 constructed as the counterpart connector of the connector 40. The substrate connector 70 includes a plurality of terminals 74 each having a female type contact section 72 coming into conductive contact with the male type contact section 48 of each terminal 42 provided on the connector 40, an electrically insulating body 76 supporting the terminals 74 with the individual contact sections 72 being exposed, and a pair of grounding members 78 supported on the body 76 while insulated from the terminals 74 and electrically connected to the shield member 60 provided on the connector 40. The body 76 is provided with a female fitting portion 80 adapted to be complimentarily fitted with the fitting portion 56 of the body 44 of the connector 40 in a state where the contact sections 72 of the terminals 74 are individually aligned to the corresponding terminals 42 of the connector 40.

The terminals 74 have the shapes and dimensions identical to each other, and are supported on the fitting portion 80 of the body 76 so as to be parallel to each other in a predetermined equidistant and side-by-side arrangement. Each terminal 74 integrally includes an attaching portion 82 at an intermediate position, press-fitted into the fitting portion 80 of the body 76, a contact section 72 at one end, extending from the attaching portion 82 to be exposed on the surface of the fitting portion 80, and a lead portion 84 at the other end, extending from the attaching portion 82 on the opposite side to the contact section 72 to protrude outside the body 76. The lead portion 84 of each terminal 74 can be connected to a conductor pad formed on a circuit substrate, not shown, onto which the substrate connector 70 is mounted.

Each grounding member 78 includes a base portion 86 having a U-shaped section and fitted into each of the longitudinally opposite end walls 76a of the body 76, and a terminal portion 88 formed so as to extend outward from one edge of the base portion 86 and generally perpendicular to the surface of the base portion 86. The grounding member 78 is attached to the end wall 76a in such a fashion that the terminal portion 88 protrudes outward from the body 76. The base portion 86 of the grounding member 78 is provided with three protuberances 90 locally formed at predetermined positions on the end wall 76a of the body 76 at a side facing to the fitting portion 80.

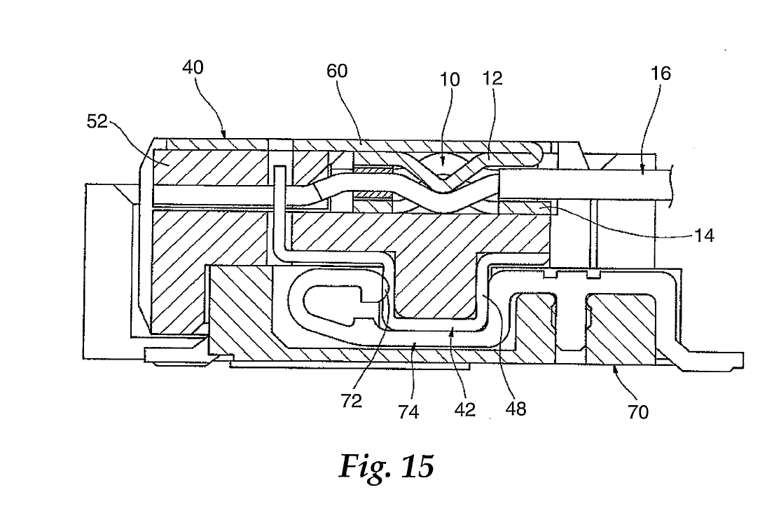

The substrate connector 70 having the above configuration is connected to the connector 40 in a mutually proper positional relationship, when the fitting portion 56 of the connector 40 is complimentarily fitted to the fitting portion 80 of the connector 70. In this proper connection state, the corresponding terminals 42, 74 are connected to each other while keeping two-point contact at the respective contact portions 48, 72 having the structurally male-female correlation. Also, in this proper connection state, the shield member 60 assembled to the second insulating member 52 of the connector 40 is electrically connected to the pair of grounding members 78 in such a manner that the three anchoring recesses 66 provided on each end plate portion (or a connecting portion) 64 respectively receive the three protuberances 90 provided on each grounding member 78 of the substrate connector 70. The mutual fitting between the anchoring recesses 66 of the shield member 60 and the protuberances 90 of the grounding member 78 functions as a latch structure for keeping the proper connection state between the connector 40 and the substrate connector 70. Furthermore, when the grounding members 78 of the substrate connector 70 are connected at their terminal portions 88 to the grounding conductor of the circuit substrate, not shown, on which the substrate connector 70 is mounted, the ground potential is given to the shield member 60 of the connector 40. As a result, a high level shield structure can be established for the signal transmission route in a connector system composed of the connector 40 and the substrate connector 70 (see FIG. 15), and the high-speed transmission performance of the connector system can be improved.

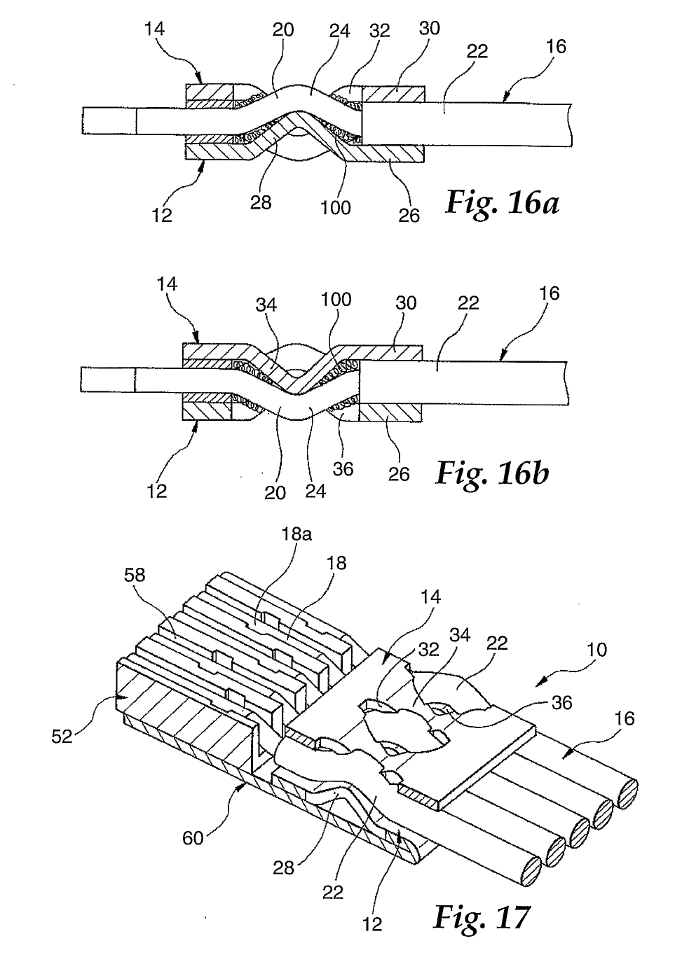

While the preferred embodiment of the present invention has been described above, the invention may include various modifications. For example, as shown in FIG. 16, the coaxial cable grounding structure 10 may be configured such that a packing material 100 is held between the first member 12 and the second member 14, together with the coaxial cables 16, so as to contact with the outer conductors 20 of the coaxial cables 16. The packing material 100 may be composed of a conductive material, such as a metallic fiber, a conductive rubber, a conductive grease, and so on, or a nonconductive material, such as a nonmetallic anti-oxidation compound, a sealing agent, and so on. The packing material 100 made of a conductive material acts to assist the electric connection between the first and second member 12, 14 and the outer conductors 20 of the coaxial cables 16. On the other hand, the packing material 100 made of a nonconductive material acts to prevent the outer conductors 20 of the coaxial cables 16 from being oxidized.

Moreover, as shown in FIG. 17 as a second embodiment of the present invention, the coaxial cable grounding structure 10 may be configured to exhibit a good grounding performance and cable holding function even when it is used with the coaxial cable 16 having no exposed length 24 (FIG. 1). The coaxial cable grounding structure 10 according to the second embodiment has substantially the same construction as the coaxial cable grounding structure 10 according to the first embodiment as described above except that the construction of the coaxial cable is different, and therefore, corresponding constituents are denoted by common reference numerals and the explanation thereof is not repeated.

In the coaxial cable grounding structure 10 according to the second embodiment, portions of the coaxial cables 16 having the sheaths 22 are respectively held between the first bulges 28 of the first member 12 and the second openings 32 of the second member 14, as well as between the first opening 36 of the first member 12 and the second bulges 34 of the second member 14. Here, when the first member 12 and the second member 14 are securely coupled to each other, an edge portion 32a (FIG. 8) of each second opening 32 is configured so as to cut into the sheath 22 of each coaxial cable 16 received in the second opening together with the first bulge 28 and to come into contact under pressure with the outer conductor 20 (FIG. 1) of the coaxial cable, and similarly, an edge portion 36a (FIG. 8) of each first opening 36 is configured so as to cut into the sheath 22 of each coaxial cable 16 received in the first opening together with the second bulge 34 and to come into contact under pressure with the outer conductor 20 (FIG. 1) of the coaxial cable. In other words, a conductor connecting function similar to the insulation-displacement type conductor connecting structure of the terminal 42 of the connector 40 is imparted to the first and second openings 36, 32 of the first and second members 12, 14.

Also with such construction, since a plurality of coaxial cables 16 are securely held, while being bent along the first and the second bulges 28, 34 of the first and the second members 12, 14, and each of the outer conductors 20 is electrically connected at 4 points to the second member 14, it is possible to connect the outer conductors 20 of a plurality of coaxial cables 16 to the first and second members 12, 14 in a mechanically and electrically stable fashion, without using a solder. Further, the provision of the insulation-displacement type conductor connecting structure advantageously makes it possible to simplify the termination processing operation of the coaxial cables 16.

In this construction, a portion of the coaxial cables 16 arranged along the first bulges 28 of the first member 12 projects more outward from the bases 30 of the second member 14 as compared to the construction in the first embodiment described above, by an amount corresponding to the thickness of the sheath 22. Thus, in view of the trends for a more slim connector system composed of the above-described connector 40 and the counterpart connector, it is advantageous in such projecting portion of the coaxial cables 16 to locally remove the sheath 22 in the region of insulation displacement connection of the first and the second members 12, 14.

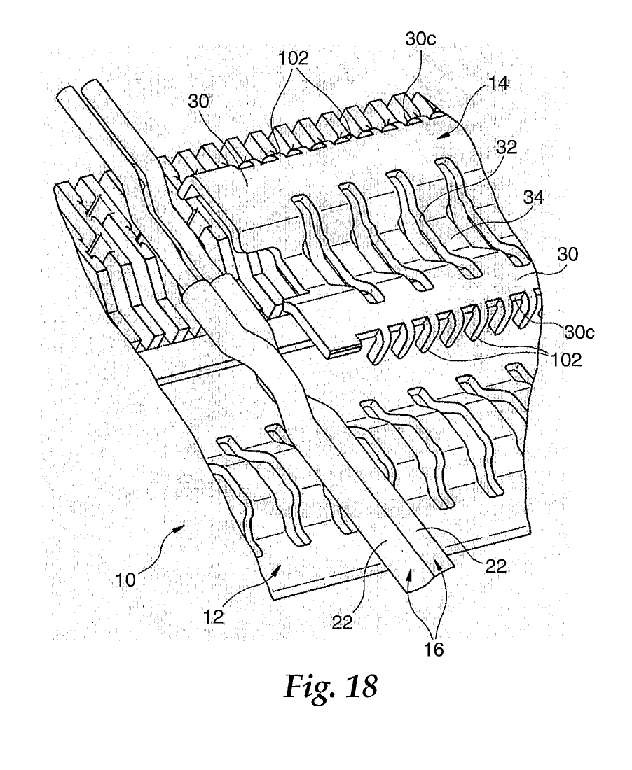

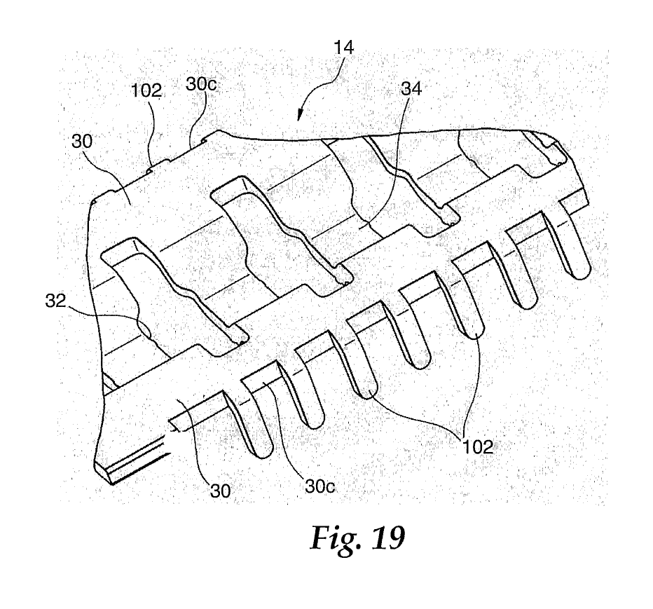

In either of the coaxial cable grounding structures 10 according to the first and the second embodiments, a plurality of holding elements can be provided on at least one of the first and the second members 12, 14 for securely holding the sheaths 22 of the coaxial cables 16 individually under pressure at positions separated from the first bulges 28 and the second openings 32. For example, as shown in FIGS. 18 and 19, a plurality of claw-like holding elements 102 extending on the same side as the second bulges 34 can be provided on each of a pair of bases 30 of the second member 12 along the side edge separated from the second openings 32 and the second bulges 34 at a predetermined equidistant interval. These holding elements 102 are constructed in a shape, dimension and interval such that a portion of one coaxial cable 16 having sheath 22 is fixedly held under pressure between neighboring holding elements 102.

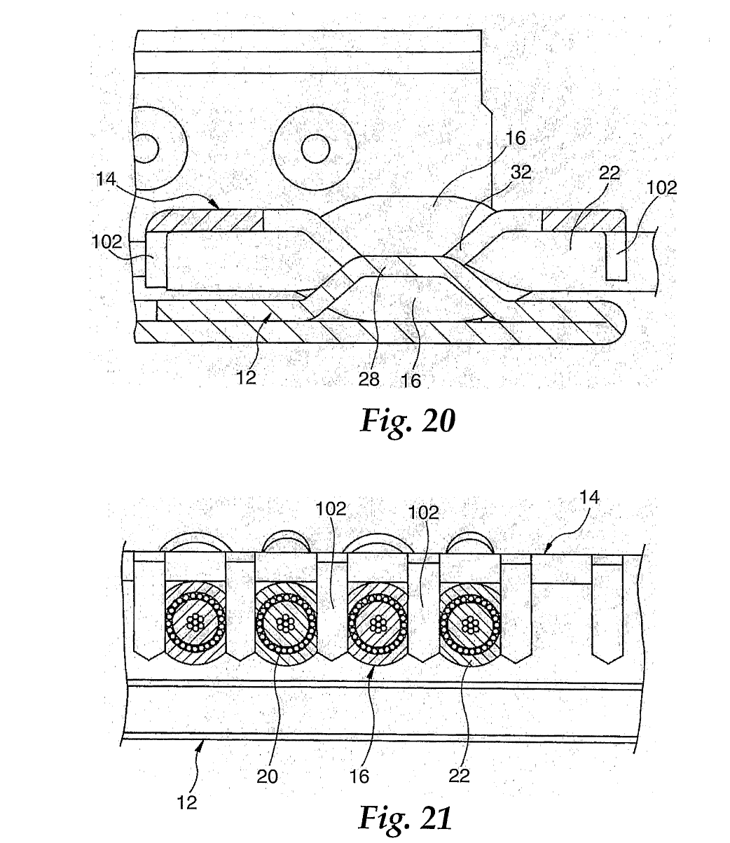

When the coaxial cable grounding structure 10 has been properly assembled (FIG. 3 or FIG. 17), the plurality of holding elements 102 act so as to hold more securely hold individually under pressure the sheaths 22 of the coaxial cables 16 securely held by friction or insulation displacement between the first bulges 28 of the first member 12 and the second openings 32 of the second member 14, and between the first openings 36 the first member 12 and the second bulges 34 of the second member 14 (FIG. 20). The cable holding function (or the tension relaxing effect) of the coaxial cable grounding structure 10 on individual coaxial cable 16 can be thereby significantly improved. Thus, by providing a plurality of holding elements 102 on the second member 14, the cable holding function by the cooperation of the first bulges 28 and the second openings 32 and the cooperation of the first openings 36 and the second bulges 34 is further enhanced, whereby the effect of external forces such as tension and bending force exerted on each of the coaxial cables 16 upon the connection points the terminals incorporated in the circuit constituents such as a connector and core wires of the coaxial cables 16 can be reliably and stably suppressed.

In the coaxial cable grounding structure 10 according to the second embodiment, when the edge portion 36a of the first openings 36 of the first member 12 and the edge portion 32a of the second openings 32 of the second member 14 respectively cut into the sheaths 22 of the coaxial cable 16 and come into conductive contact with the outer conductors (FIG. 1) in an insulation-displacing manner, it is advantageous to construct such that, before such an insulation displacement, the plurality of holding elements hold the sheaths 22 of individual coaxial cables 16 under pressure. With such construction, each coaxial cable 16 is mechanically held by the corresponding holding elements 102 on both longitudinal sides of the insulation displacement region, and therefore, the insulation displacement region of the coaxial cable 16 is maintained under the required tension during the insulation displacement, so that the stability of the insulation displacement operation is improved.

Further, in either of the first and the second embodiments, it is advantageous that the plurality of holding elements 102 are constructed so as to individually cut into the sheath 22 of the each of the coaxial cables 16 securely held between the first bulges 28 and the second openings 32 and between the first openings 36 and the second bulges 34, and to come into contact under pressure with the outer conductor 20 of the coaxial cable 16. With this construction, the multi-point connecting structure as described above of the coaxial cable grounding structure 10 with increased number of conductive contact points can be electrically and mechanically further stabilized.

1. A coaxial cable grounding structure comprising a conductive first member and a conductive second member fixedly arranged on said first member, wherein a plurality of coaxial cables are held between said first member and said second member, and said first member and said second member are electrically connected individually to outer conductors of the coaxial cables, characterized in that:
each of said coaxial cables has an exposed length with said outer conductor locally exposed;
said first member includes a first bulge for supporting exposed lengths of a first group of said coaxial cables and brought into contact with the outer conductors of said exposed lengths;
said second member includes a second opening for receiving said first bulge of said first member and said exposed lengths of said first group of said coaxial cables supported on said first bulge; and
when said first member and said second member are securely coupled to each other, said exposed lengths of said first group of said coaxial cables are fixedly held by a friction force, while being bent along said first bulge, between said first bulge of said first member and said second opening of said second member.

2. A coaxial cable grounding structure as set forth in claim 1, wherein said first member includes a plurality of first bulges for individually supporting said exposed lengths of said first group of said coaxial cables; and wherein said second member includes a plurality of second openings for individually receiving said first bulges and said exposed lengths of said first group of said coaxial cables individually supported on said first bulges.

3. A coaxial cable grounding structure as set forth in claim 1, wherein said second opening of said second member includes an edge portion coming into local contact with said outer conductors of said exposed lengths of said first group of said coaxial cables received in said second opening.

4. A coaxial cable grounding structure as set forth in claim 3, wherein said first bulge of said first member includes a crest area projecting through said second opening of said second member, and supports said exposed lengths of said first group of coaxial cables with the exposed lengths being bent along said crest area, to locally press said outer conductors of said exposed lengths onto said edge portion of said second opening.

5. A coaxial cable grounding structure as set forth in claim 1, wherein said second opening of said second member includes an edge portion coming into local frictional engagement with said first bulge of said first member received in said second opening.

6. A coaxial cable grounding structure as set forth in claim 1, wherein said second member further includes a second bulge, arranged adjacent to said second opening, for supporting said exposed lengths of a second group of said coaxial cables and brought into contact with said outer conductors of said exposed lengths; wherein said first member further includes a first opening, arranged adjacent to said first bulge, for receiving said second bulge of said second member and said exposed lengths of said second group of said coaxial cables supported on said second bulge; and wherein said exposed lengths of said second group of said coaxial cables are bent along said second bulges and fixedly held by a friction force, while being bent along said second bulge, between said first opening of said first member and said second bulge of said second member.

7. A coaxial cable grounding structure as set forth in claim 6, wherein said second member includes a plurality of second bulges for individually supporting said exposed lengths of said second group of said coaxial cables; and wherein said first member includes a plurality of first openings for individually receiving said second bulges and said exposed lengths of said second group of said coaxial cables individually supported on said second bulges.

8. A coaxial cable grounding structure as set forth in claim 6, wherein said first opening of said first member includes an edge portion coming into local contact with said outer conductors of said exposed lengths of said second group of coaxial cables received in said first opening.

9. A coaxial cable grounding structure as set forth in claim 8, wherein said second bulge of said second member includes a crest area projecting through said first opening of said first member, and supports said exposed lengths of said second group of coaxial cables with the exposed lengths being bent along said crest area, to locally press said outer conductors of said exposed lengths onto said edge portion of said first opening.

10. A coaxial cable grounding structure as set forth in claim 6, wherein said first opening of said first member includes an edge portion coming into local frictional engagement with said second bulge of said second member received in said first opening.

11. A coaxial cable grounding structure as set forth in claim 6, wherein said first bulge and said first opening of said first member are arranged alternately to each other; and wherein said second bulge and said second opening of said second member are arranged alternately to each other and corresponding to an alternate arrangement of said first bulge and said first opening.

12. A coaxial cable grounding structure as set forth in claim 11, wherein a shape and a dimension of said first bulge of said first member is defined by shapes, dimensions and pitch of a pair of first openings arranged at both sides of said first bulge, wherein a shape and a dimension of said second bulge of said second member is defined by shapes, dimensions and pitch of a pair of second openings arranged at both sides of said second bulge, and wherein, when said first bulge is press-fitted into said second opening and said second bulge is press-fitted into said first opening, said first member and said second member are securely held with each other.

13. A coaxial cable grounding structure comprising a conductive first member and a conductive second member fixedly arranged on said first member, wherein a plurality of coaxial cables are held between said first member and said second member, and said first member and said second member are electrically connected, individually, to outer conductors of the coaxial cables, characterized in that:
said first member includes a plurality of first bulges for individually supporting said coaxial cables;
said second member includes a plurality of second openings for individually receiving said first bulges of said first member and said coaxial cables individually supported on said first bulges; and
when said first member and said second member are securely coupled to each other, edge portions of said second openings respectively cut into sheaths of said coaxial cables individually received in said second openings together with said first bulges, to securely hold said coaxial cables in a form bent along said first bulges, and to come into contact with said outer conductors of said coaxial cables under pressure.

14. A coaxial cable grounding structure as set forth in claim 1, further comprising a packing material held between said first member and said second member and contacting with said outer conductors of said coaxial cables.

15. A coaxial cable grounding structure as set forth in claim 1, further comprising a plurality of holding elements provided on at least one of said first member and said second member for securely holding, individually and under pressure, the sheaths of said coaxial cables fixedly held between said first bulges and said second openings, at a position remote from said first bulges and said second openings.

16. A coaxial cable grounding structure as set forth in claim 15, wherein said plurality of holding elements individually cut into said sheaths of said coaxial cables fixedly held between said first bulges and said second openings, and come into contact with said outer conductors of said coaxial cables under pressure.

17. A connector comprising a coaxial cable grounding structure as set forth in claim 1.

18. A connector as set forth in claim 17, further comprising a plurality of terminals, a body supporting said terminals and said coaxial cables in corresponding arrangements, and a shield member assembled to said body, wherein said shield member is provided with said first member of said coaxial cable grounding structure and a connecting portion for electrically connecting said first member to a grounding potential of a counterpart connector.

19. A method for connecting a coaxial cable in a connector as set forth in claim 18, wherein each of said terminals of said connector includes an insulation-displacement type conductor-connecting section connectable to a core conductor of each of said coaxial cables, said method comprising the steps of:
locating said coaxial cables on said body and said shield member so as to lay said coaxial cables on said first bulge;
receiving said first bulge and said coaxial cables supported on said first bulge in said second opening, so as to secure said second member onto said first member; and
attaching said terminals under a pressing force to said body having said coaxial cables located thereon, and connecting each of said coaxial cables to said conductor-connecting section of each of said terminals in an insulation displacing manner.
